(19) United States
(12) Patent Application Publication
(10) Pub. No.: US 2024/0259570 A1
(43) Pub. Date: Aug. 1, 2024

(54) METHOD AND APPARATUS FOR VIDEO ENCODING/DECODING USING A GEOMETRIC PARTITIONING MODE

(71) Applicants: HYUNDAI MOTOR COMPANY, Seoul (KR); KIA CORPORATION, Seoul (KR)

(72) Inventors: Seung Wook Park, Yongin-si (KR); Jin Heo, Yongin-si (KR)

(73) Assignees: HYUNDAI MOTOR COMPANY, Seoul (KR); KIA CORPORATION, Seoul (KR)

(21) Appl. No.: 18/627,971

(22) Filed: Apr. 5, 2024

Related U.S. Application Data
(63) Continuation of application No. PCT/KR2022/015048, filed on Oct. 6, 2022.

(30) Foreign Application Priority Data
Oct. 6, 2021 (KR) 10-2021-0132512
Oct. 5, 2022 (KR) 10-2022-0127389

(51) Int. Cl. H04N 19/159; H04N 19/176

(52) U.S. Cl. CPC H04N 19/159; H04N 19/176

(57) ABSTRACT

A method for decoding a video includes partitioning a current block into a first region and a second region. The method also includes determining whether the first region utilizes an intra-prediction mode or an inter-prediction mode. The method additionally includes determining whether the second region utilizes the intra-prediction mode or the inter-prediction mode. The method also includes generating intra prediction block for a region that utilizes the intra-prediction mode among the first region and the second region. The method also includes generating inter prediction block for a region that utilizes the inter-prediction mode among the first region and the second region. The method further includes generating a prediction block of the current block, based on prediction block for the first region and prediction block for the second region.

### CROSS-REFERENCE TO RELATED APPLICATIONS

This application is a Continuation of International Application No. PCT/KR2022/015048, filed on Oct. 6, 2022, which claims priority to and the benefit of Korean Patent Application No. 10-2021-0132512 filed on Oct. 6, 2021, and Korean Patent Application No. 10-2022-0127389 filed on Oct. 5, 2022, the entire disclosures of each of which are incorporated herein by reference.

### TECHNICAL FIELD

The present disclosure relates to a method and apparatus for video encoding/decoding using a geometric partitioning mode.

### BACKGROUND

The content described in this section merely provides background information related to the present disclosure and does not constitute prior art.

Because the volume of video data is larger than that of voice data or still image data, storing or transmitting video data without processing the video data by compression requires a lot of hardware resources including memory.

Accordingly, in storing or transmitting video data, the video data is generally compressed using an encoder so as to be stored or transmitted. Then, a decoder receives the compressed video data and decompresses and reproduces the video data. Compression techniques for such video data include H.264/AVC, high efficiency video coding (HEVC), and versatile video coding (VVC) which improves coding efficiency by about 30% or more compared to HEVC.

However, the video size, resolution, and frame rate are gradually increasing, and thus the amount of data to be encoded is also increasing. Accordingly, a new compression technique having better encoding efficiency and higher image quality than the existing compression technique is required.

Geometric partitioning mode is a method of generating the prediction block of the current block by weighted averaging two inter-prediction signals that are generated by partitioning one coding unit (CU) into two regions and performing inter prediction independently in the two partitioned regions. There is a need for using various combinations of intra-prediction mode and inter-prediction mode rather than using only the inter-prediction mode in geometric partitioning mode.

### SUMMARY

An object of the present disclosure is to provide a method and apparatus for generating a prediction block of the current block based on a geometric partitioning mode.

Another object of the present disclosure is to provide a method and apparatus for generating a prediction block of the current block by applying an inter-prediction mode and an intra-prediction mode to each of the two regions partitioned in the geometric partitioning mode.

Another object of the present disclosure is to provide a method and apparatus for generating a prediction block of the current block by variously combining an inter-prediction mode and an intra-prediction mode in the geometric partitioning mode.

Another object of the present disclosure is to provide a method and apparatus for enhancing prediction accuracy in the geometric partitioning mode.

Another object of the present disclosure is to provide a method and apparatus for improving video encoding/decoding efficiency.

Another object of the present disclosure is to provide a recording medium that stores a bitstream generated by a video encoding/decoding method or a video encoding/decoding apparatus of the present disclosure.

Another object of the present disclosure is to provide a method and an apparatus for transmitting a bitstream generated by a video encoding/decoding method or an apparatus of the present disclosure.

According to an embodiment of the present disclosure, a video decoding method is provided. The video decoding method includes partitioning a current block into a first region and a second region. The video decoding method also includes determining whether the first region utilizes an intra-prediction mode or an inter-prediction mode. The video decoding method further includes determining whether the second region utilizes the intra-prediction mode or the inter-prediction mode. The video decoding method also includes generating intra prediction block for a region that utilizes the intra-prediction mode among the first region and the second region, based on at least one of a most probable mode (MPM) list, intra-prediction modes of one or more blocks adjacent to the current block, one or more reference pixels adjacent to the current block, or a third region adjacent to the current block. The video decoding method additionally includes generating inter prediction block for a region that utilizes the inter-prediction mode among the first region and the second region. The video decoding method further includes generating a prediction block of the current block, based on prediction block for the first region and prediction block for the second region.

According to another embodiment of the present disclosure, a video encoding method is provided. The video encoding method includes: partitioning a current block into a first region and a second region, and determining whether the first region utilizes an intra-prediction mode or an inter-prediction mode. The video encoding method also includes determining whether the second region utilizes the intra-prediction mode or the inter-prediction mode. The video encoding method additionally includes generating intra prediction block for a region the utilizes the intra-prediction mode among the first region and the second region, based on at least one of a most probable mode (MPM) list, intra-prediction modes of one or more blocks adjacent to the current block, one or more reference pixels adjacent to the current block, or a third region adjacent to the current block. The video encoding method further includes generating inter prediction block for a region that utilizes the inter-prediction mode among the first region and the second region. The video encoding method additionally includes generating a prediction block of the current block, based on prediction block for the first region and prediction block for the second region.

According to embodiments of the present disclosure, a method is provided for transmitting a bitstream generated by the video encoding method or apparatus according to embodiments of the present disclosure.

In addition, according to embodiments of the present disclosure, a recording medium is provided for storing a bitstream generated by the video encoding method or apparatus according to embodiments of the present disclosure.

In addition, according to embodiments of the present disclosure, a recording medium is provided for storing a bitstream received and decoded by the video decoding apparatus according to embodiments of the present disclosure and used to reconstruct a video.

According to the embodiments of present disclosure, a method and an apparatus are provided for generating a prediction block of the current block based on the geometric partitioning mode.

In addition, according to embodiments of the present disclosure, a method and an apparatus are provided for generating a prediction block of the current block by applying an inter-prediction mode and an intra-prediction mode to each of the two regions partitioned in the geometric partitioning mode.

In addition, according to embodiments of the present disclosure, a method and an apparatus are provided for generating a prediction block of the current block by variously combining an inter-prediction mode and an intra-prediction mode in the geometric partitioning mode.

In addition, according to embodiments of the present disclosure, a method and an apparatus are provided for enhancing prediction accuracy in the geometric partitioning mode.

In addition, according to embodiments of the present disclosure, the method and an apparatus are provided for improving video encoding/decoding efficiency may be provided.

The effects that may be obtained from the present disclosure are not limited to the effects mentioned above. Other effects not mentioned may be clearly understood by those having ordinary skill in the art from the description below.

### BRIEF DESCRIPTION OF THE DRAWINGS

FIG. 1 is a block diagram of a video encoding apparatus that may implement a technology of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement technologies of the present disclosure.

FIG. 6 is a diagram illustrating a method of applying a geometric partitioning mode to a 32×32 block, according to at least one embodiment of the present disclosure.

FIG. 7A and FIG. 7B are diagrams illustrating an angle parameter and a distance parameter in geometric partitioning mode, according to some embodiments of the present disclosure.

FIG. 8 is a diagram illustrating a lookup table of partition direction information in geometric partitioning mode, according to at least one embodiment of the present disclosure.

FIGS. 9A and 9B are diagrams illustrating an error distribution of inter prediction and an error distribution of intra prediction, according to at least one embodiment of the present disclosure.

FIG. 10 is a diagram illustrating a first region, a second region and surrounding reference pixels in a geometric partitioning mode, according to at least one embodiment of the present disclosure.

FIG. 11 is a diagram illustrating reference blocks neighboring a first region in the geometric partitioning mode, according to at least one embodiment of the present disclosure.

FIGS. 12A and 12B are diagrams illustrating reference blocks neighboring first regions in geometric partitioning mode, according to at least some other embodiments of the present disclosure.

FIG. 13 is a diagram illustrating syntaxes for intra-prediction mode in geometric partitioning mode, according to at least one embodiment of the present disclosure.

FIG. 14 is a diagram illustrating templates and reference pixels used by a template-based intra-prediction mode derivation in geometric partitioning mode, according to at least one embodiment of the present disclosure.

FIGS. 15A and 15B are diagrams illustrating templates and reference pixels used by a template-based intra-prediction mode derivation in geometric partitioning mode, according to at least some other embodiments of the present disclosure.

FIG. 16 is a diagram illustrating reference pixels for applying a sobel operation in geometric partitioning mode, according to at least one embodiment of the present disclosure.

FIGS. 17A and 17B are diagrams illustrating reference pixels for applying a sobel operation in geometric partitioning mode, according to at least some other embodiments of the present disclosure.

FIG. 18 is a diagram illustrating neighboring blocks of the current block for applying a histogram of modes in geometric partitioning mode, according to at least one embodiment of the present disclosure.

FIG. 19A, FIG. 19B, FIG. 19C, and FIG. 19D are diagrams illustrating neighboring blocks of the current block for applying a histogram of modes in geometric partitioning mode, according to at least some other embodiments of the present disclosure.

FIG. 20 is a diagram illustrating a method of combining an intra-prediction mode and an inter-prediction mode in geometric partitioning mode, according to at least one embodiment of the present disclosure.

FIG. 21 is a diagram illustrating syntaxes for combining an intra-prediction mode and an inter-prediction mode in geometric partitioning mode, according to at least one embodiment of the present disclosure.

FIG. 22 is a diagram illustrating syntaxes for intra-prediction mode in geometric partitioning mode, according to at least one embodiment of the present disclosure.

FIG. 23 is a diagram illustrating syntaxes for inter-prediction mode in geometric partitioning mode, according to at least one embodiment of the present disclosure.

FIG. 24 is a diagram illustrating a video decoding process according to at least one embodiment of the present disclosure.

FIG. 25 is a diagram illustrating a video encoding process according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, even when the elements are illustrated in different drawings. Further, in the following description of some embodiments, detailed descriptions of related known components and functions, when considered to obscure the subject of the present disclosure, have been omitted for the purpose of clarity and for brevity.

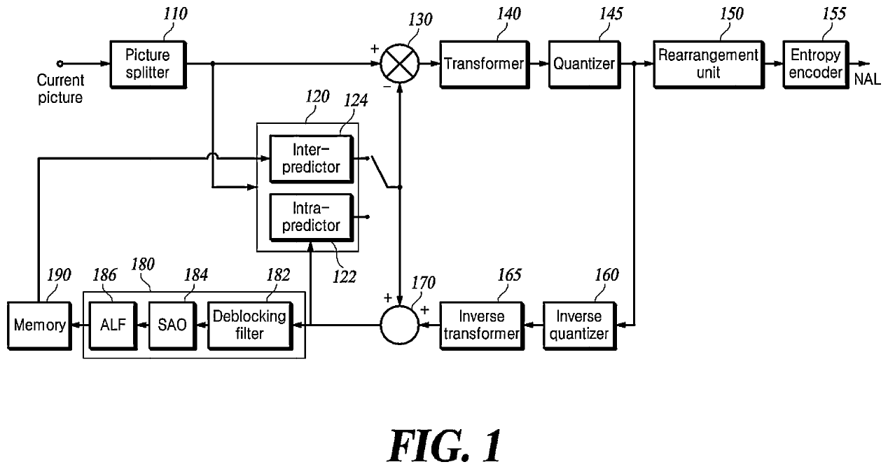

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software, or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. One or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information that the plurality of pictures commonly refers to, is encoded to a sequence parameter set (SPS). In addition, information that one or more SPS commonly refer to is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. As another example, the tree structure may be a binarytree (BT) in which the higher node is split into two lower nodes. As yet another example, the tree structure may be a ternarytree (TT) in which the higher node is split into three lower nodes at a ratio of 1:2:1. As still another example, the tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. A BTTT is added to the tree structures to be referred to as a multiple-type tree (MTT).

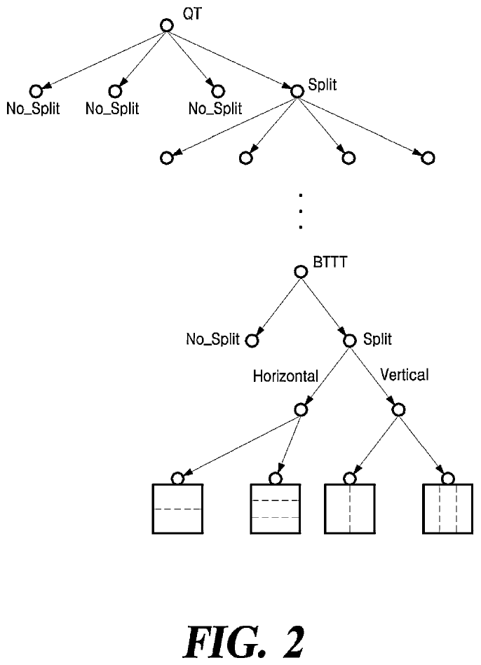

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, e.g., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, e.g., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. A type in which the block of the corresponding node is split into two blocks of a form of being asymmetrical to each other may be additionally present. The asymmetrical form may include a form in which the block of the corresponding node is split into two rectangular blocks having a size ratio of 1:3 and/or may include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block”. As the QTBTTT splitting is adopted, a shape of the current block may be a rectangular shape or a square shape.

The predictor 120 predicts the current block to generate a prediction block. The predictor 120 includes an intra predictor 122 and an inter predictor 124.

In general, each of the current blocks in the picture may be predictively coded. The prediction of the current block may be performed by using an intra prediction technology (using data from the picture including the current block) or an inter prediction technology (using data from a picture coded before the picture including the current block). The inter prediction includes both unidirectional prediction and bidirectional prediction.

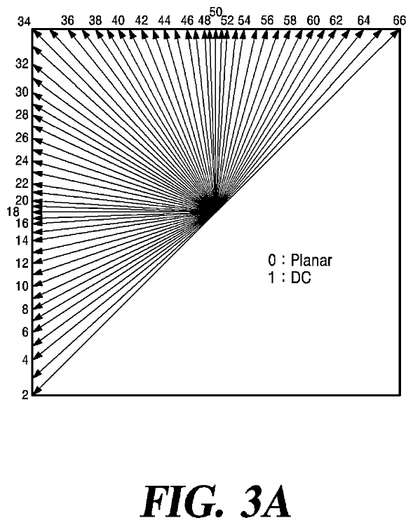

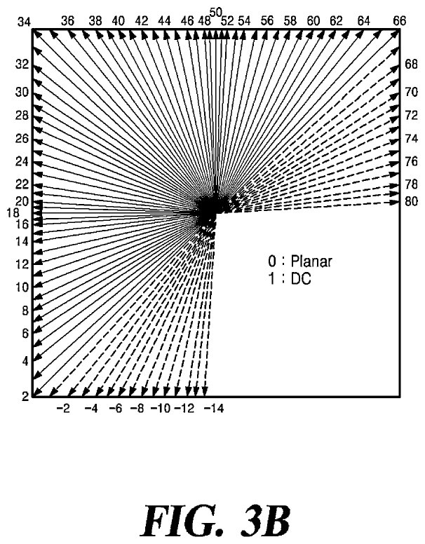

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode. The plurality of intra prediction modes may also include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation may be performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, etc. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference as described below.

The inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block may be generated by averaging or weighted-averaging the first reference block and the second reference block. Motion information including information on two reference pictures used for predicting the current block and including information on two motion vectors is delivered to the entropy encoder 155. Reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

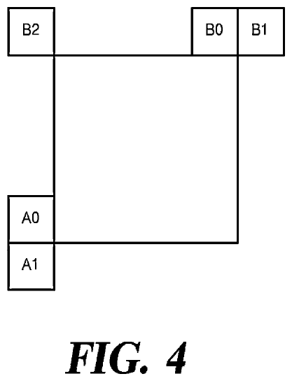

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (which may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector may be added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (which may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector may be added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be obtained by applying a pre-defined function (e.g., center value and average value computation, etc.) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

The motion vector predictor may also be determined by a scheme of selecting any one of the motion vector predictor candidates. In this case, information for identifying the selected motion vector predictor candidate is encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit. In another embodiment, the transformer 140 may split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. The transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal flag) and/or positional information (cu_sbt_pos_flag) are encoded by the entropy encoder 155 and signaled to the video decoding apparatus. As another example, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

The transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. In another embodiment, the quantizer 145 may immediately quantize the related residual block without the transform for any block or frame. In an embodiment, the quantizer 145 may apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may be used instead of the zig-zag scan. In an embodiment, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1 D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information such as a CTU size, a CTU split flag, a QT split flag, an MTT split type, an MTT split direction, etc., related to the block splitting to allow the video decoding apparatus to split the block in the same manner as the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered by the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

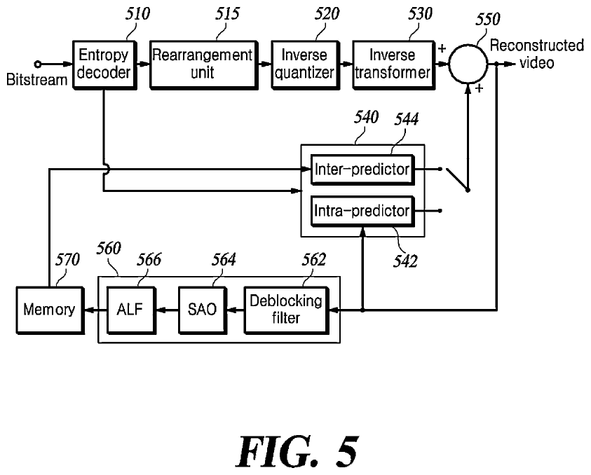

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may be implemented to execute the function of the software corresponding to each component.

The entropy decoder 510 extracts information related to block splitting by decoding the bitstream generated by the video encoding apparatus to determine a current block to be decoded. The entropy decoder 510 also extracts prediction information required for restoring the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

When the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1 D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by restoring the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 may be activated when the prediction type of the current block is the intra prediction. The inter predictor 544 may be activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered by the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

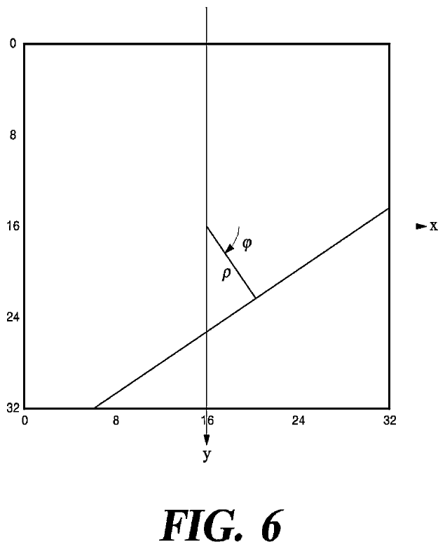

FIG. 6 is a diagram illustrating a method of applying a geometric partitioning mode to a 32×32 block, according to at least one embodiment of the present disclosure. In the geometric partitioning mode, a coding unit may be partitioned into two regions by a straight partitioning line. Each of the two partitioned regions may perform inter prediction by using different motion information. An inter prediction block for each of the two partitioned regions may be generated. By weighted averaging the two generated inter prediction blocks, a final prediction block in the geometric partitioning mode may be generated. The geometric partitioning mode uses an angle parameter and a distance parameter to set partitioning boundary regions defined by a straight line.

Referring to FIG. 6, the 32×32 block may be partitioned into two regions. Inter prediction may be performed for each of the two partitioned regions. (p may be equivalent to an angle parameter. ρ may be equivalent to a distance parameter. Using the angle parameter and the distance parameter, a straight line may be established that divides the 32×32 block.

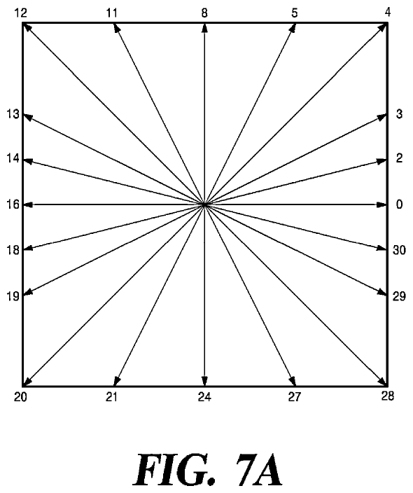

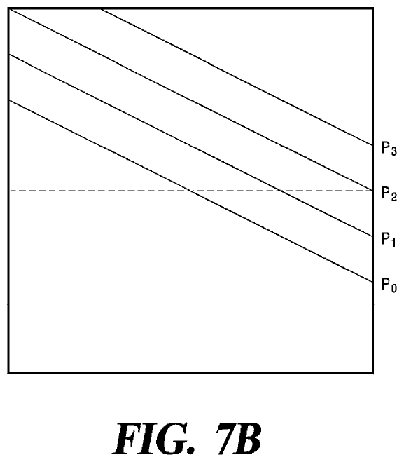

FIG. 7A and FIG. 7B are diagrams illustrating an angle parameter and a distance parameter in geometric partitioning mode, according to some embodiments of the present disclosure.

Referring to FIG. 7A, the angle parameter may be defined by a total of 20 quantized angles by symmetrically dividing a 360-degree range within the coding unit.

Referring to FIG. 7B, the distance parameter may be defined by four quantized distances. Of the total of 80 possible partition directions that may occur with combinations of angle parameters and distance parameters, 10 redundant partition directions and 6 redundant partition directions with binary tree partitions and triple tree partitions may be excluded. This leaves a total of 64 partition directions that may be utilized by the geometric partitioning mode.

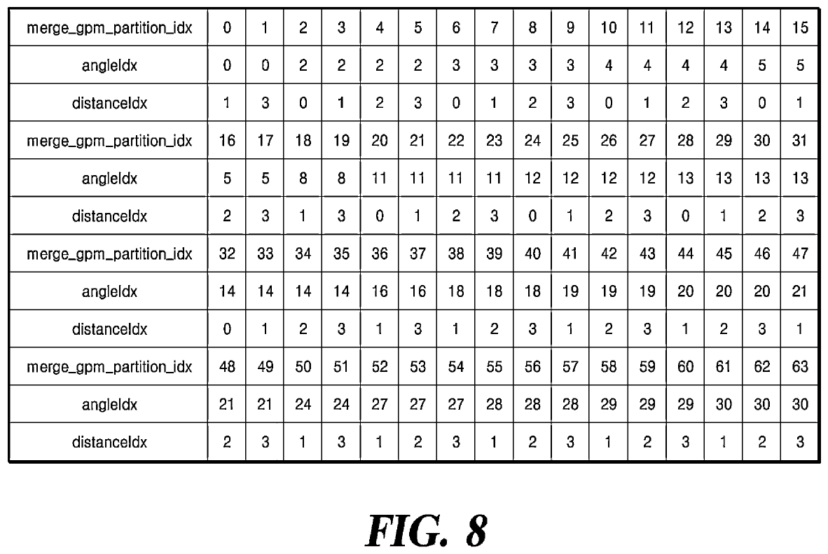

FIG. 8 is a diagram illustrating a lookup table of partition direction information in geometric partitioning mode, according to at least one embodiment of the present disclosure. Combinations of the angle parameters and the distance parameters may be defined as a look-up table. For each coding unit, the partition direction information may be transmitted. The geometric partitioning mode may construct, from the regular merge candidate list, a merge candidate list which is for the geometric partitioning mode and includes only unidirectional motion information. This may simplify the encoding of motion information and reduce the number of possible combinations. Using the merge candidate list for the geometric partitioning mode, the used merger index for each partitioned region may be transmitted.

Referring to FIG. 8, partition direction information (e.g., merge_gpm_partition_idx) may be determined based on information on angle parameters (e.g., angleIdx) and information on distance parameters (e.g., distanceIdx). The merge_gpm_partition_idx by the combinations of angleIdx and distanceIdx may be defined as the lookup table. The value of merge_gpm_partition_idx may be in the range from 0 to 63. A merge_gpm_partition_idx may be transmitted for each coding unit.

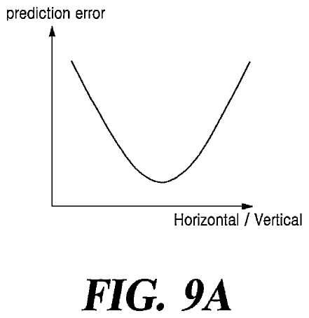

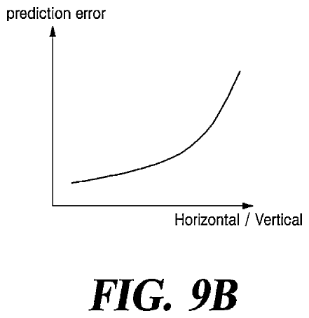

FIGS. 9A and 9B are diagrams illustrating an error distribution of inter prediction and an error distribution of intra prediction, according to at least one embodiment of the present disclosure.

Referring to FIG. 9A, the error distribution of inter prediction may be exhibited based on horizontal/vertical coordinate values. In inter prediction, a motion vector may be used relative to the center of the current block. Accordingly, the farther outward from the center of the current block, the greater the error of the inter prediction may become.

Referring to FIG. 9B, the error distribution of intra prediction may be exhibited based on horizontal/vertical coordinate values. In intra prediction, a reference block used in the prediction may be at the upper left of the current block. Accordingly, the error of the intra prediction may increase from the upper left to the lower right.

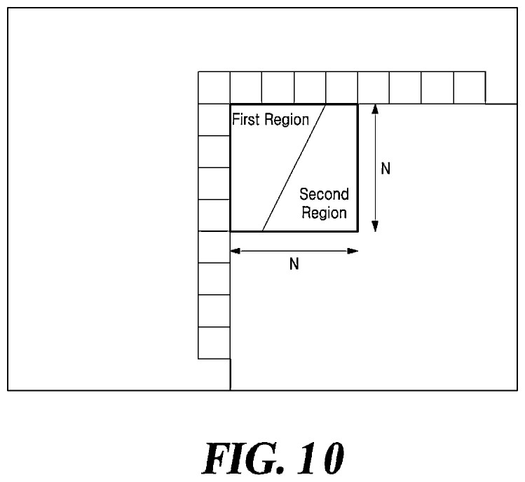

FIG. 10 is a diagram illustrating a first region, a second region and surrounding reference pixels in a geometric partitioning mode, according to at least one embodiment of the present disclosure. In geometric partitioning mode, one coding unit may be partitioned into two regions. Each of the partitioned regions may be classified as a first region and a second region. Inter prediction signals for the first region and the second region may be generated by using independent motion information items for the first region and the second region. To simplify the encoding of the motion information and reduce the number of combinations, from a regular merge candidate list, a merge candidate list for geometric partitioning mode may be generated, containing only unidirectional motion information.

By applying an intra-prediction mode to the first region, an intra prediction signal may be generated, and an inter prediction signal may be generated by applying an inter-prediction mode to the second region. The second region may use motion information for inter prediction from the regular merge candidate list containing bidirectional motion information.

Referring to FIG. 10, one coding unit may be divided into a first region and a second region according to a geometric partitioning mode. One coding unit may be equivalent to an N×N block. There may be neighboring reference pixels in the periphery of the one coding unit. One coding unit may be equal to the current block. To the first region, the intra-prediction mode may be applied because the error of intra prediction increases toward the lower right region of the current block. The first region includes the upper left pixel. To the second region, the inter-prediction mode may be applied because the error of the intra prediction increases toward the lower right region of the current block. The second region is farther away from the reference pixels. The first region may use intra-prediction mode to generate an intra prediction block and the second region may use inter-prediction mode to generate an inter prediction block. Because encoding of motion information may be performed for only the second region, coding efficiency may be improved. The prediction block of the current block may be generated by weighted averaging the intra prediction block generated in the first region and the inter prediction block generated in the second region. The weighted averaging may be equivalent to a weighted summing. The intra prediction block generated in the first region and the inter prediction block generated in the second region may be independently encoded and decoded.

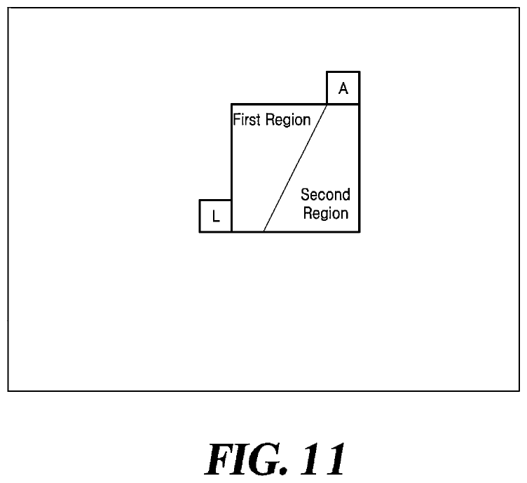

FIG. 11 is a diagram illustrating reference blocks neighboring a first region in the geometric partitioning mode, according to at least one embodiment of the present disclosure. In geometric partitioning mode, the first region may undergo intra prediction by using a most probable mode (MPM) list. The MPM list may be generated by using the intra-prediction mode of the neighboring blocks of the current block.

Referring to FIG. 11, in geometric partitioning mode, the current block may be divided into a first region and a second region. Neighboring reference blocks may be present on the periphery of the current block. There may be an A block adjacent to the top of the current block and an L block adjacent to the left of the current block. The A mode may be equivalent to the intra-prediction mode of the A block. The L mode may be equivalent to the intra-predict mode of the L block. The A mode and the intra-prediction mode of the A block may be used interchangeably. L mode and the intra-prediction mode of the L block may be used interchangeably. The MPM list may be generated by using the A mode and the L mode. The first region may utilize the MPM list to perform intra prediction.

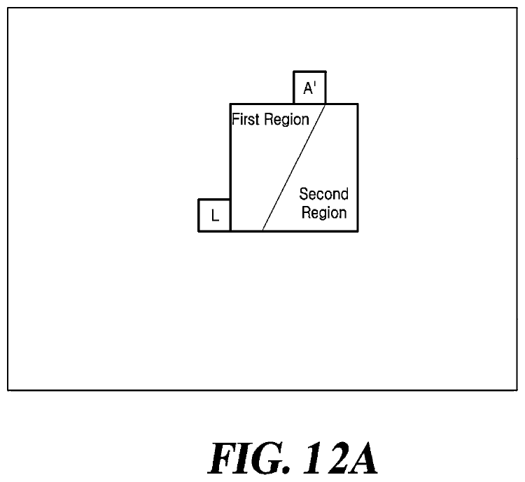

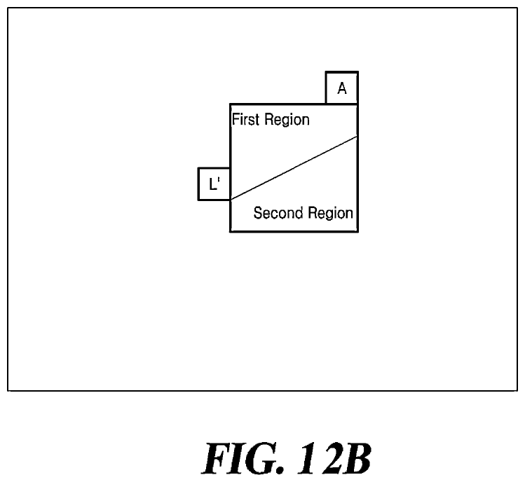

FIGS. 12A and 12B are diagrams illustrating reference blocks neighboring first regions in geometric partitioning mode, according to at least some other embodiments of the present disclosure.

Referring to FIG. 12A, in geometric partitioning mode, the current block may be partitioned into a first region and a second region. A partitioning boundary may exist from top to bottom. With respect to the first region, there may be a reference block, A′ block, adjacent to the top of the first region. There may be an L block adjacent to the left side of the first region. An MPM list may be generated by using the A′ mode and L mode. The first region may utilize the generated MPM list to perform intra prediction.

Referring to FIG. 12B, in geometric partitioning mode, the current block may be partitioned into a first region and a second region. The partitioning boundary may be present extending from left to right. With respect to the first region, there may be a reference block, A block, adjacent to the top of the first region. There may be an L′ block adjacent to the left side of the first region. An MPM list may be generated by using the A mode and L′ mode. The first region may use the generated MPM list to perform intra prediction. The present disclosure is not limited to these embodiments, and the position of the upper reference block and the position of the left reference block may be variably determined by considering the partitioning boundary of the current block.

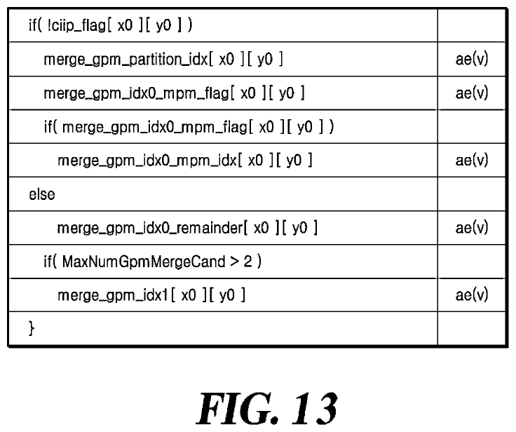

FIG. 13 is a diagram illustrating syntaxes for intra-prediction mode in geometric partitioning mode, according to at least one embodiment of the present disclosure. The transmission method of the syntax for intra-prediction mode in the first region may be the same as that of the syntax for intra-prediction mode using a conventional MPM list. The transmission method of the syntaxes for the inter-prediction mode of the second region may be the same as that of the syntaxes for the conventional inter-prediction mode.

Referring to FIG. 13, a partition form of the current block may be determined based on merge_gpm_partition_idx. Information indicating whether the first region performs intra prediction by using the MPM list (e.g., merge_gpm_idx0_mpm_flag) may be signaled. If merge_gpm_idx0_mpm_flag is a first value (e.g., 0), merge_gpm_idx0_remainder may be signaled. The first region may use merge_gpm_idx0_remainder to determine information on the intra-prediction mode. If merge_gpm_idx0_mpm_flag is a second value (e.g., 1), merge_gpm_idx0_mpm_idx may be signaled. The first region may determine the information on the intra-prediction mode from the MPM list. Regarding inter prediction in the second region, merge_gpm_idx1 may be signaled. Using merge_gpm_idx1, motion information may be determined from the merge candidate list.

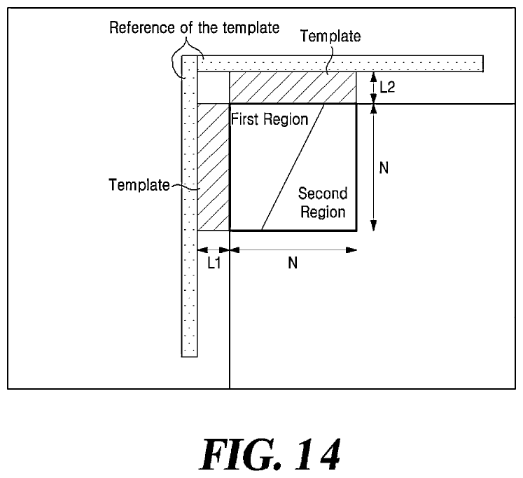

FIG. 14 is a diagram illustrating templates and reference pixels used by a template-based intra-prediction mode derivation in geometric partitioning mode, according to at least one embodiment of the present disclosure. The information on the intra-prediction mode of the first region may be implicitly transmitted. In this case, the decoding apparatus may derive the information on the intra-prediction mode. There may be three ways to implicitly transmit information on the intra-prediction mode in a geometric partitioning mode. The first method is template-based intra-prediction mode derivation. The second method is the sobel operation-based intra-prediction mode derivation. The third method is a mode histogram-based intra-prediction mode derivation.

Using templates adjacent to the first region, the intra-prediction mode of the first region may be derived. A prediction template may be generated by applying the directionalities of all candidate modes in the MPM list to reference pixels in the templates. The Sum of Absolute Transformed Difference (SATD) of the pixels of the generated prediction template and the pixels of the already reconstructed template may be calculated. Among the MPM candidate modes, the MPM candidate mode utilized to calculate the value with the smallest sum of absolute transformed difference is the intra-prediction mode of the first region derived by the template-based intra-prediction mode derivation.

Referring to FIG. 14, the current block of size N×N may be partitioned into the first region and the second region according to a geometric partitioning mode. The neighboring templates may exist on the periphery of the current block. The size of the template adjacent to the left side of the current block may be L1×N. The size of the template adjacent to the top of the current block may be N×L2. The intra-prediction mode of the first region may be derived by using the template-based intra-prediction mode derivation. An MPM list may be generated by any of the MPM list generation methods described in FIGS. 11, 12A, and 12B. A prediction template may be generated by applying the respective candidate modes in the generated MPM list to reference pixels in the templates. The sum of absolute transformed difference may be calculated between the pixels in the prediction template and the pixels in the already reconstructed template. The candidate mode, which is in the MPM list, used to calculate the value with the smallest sum of absolute transformed difference may be the intra-prediction mode of the first region.

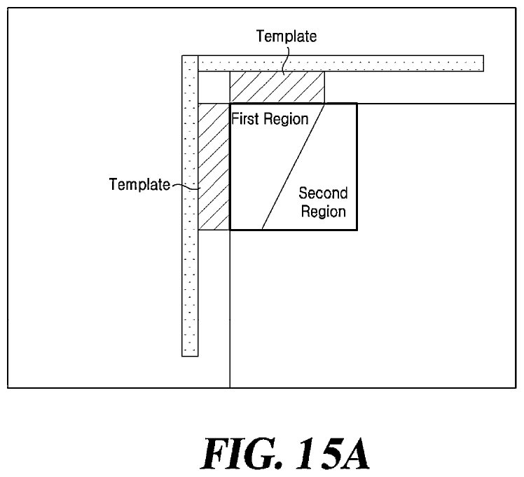

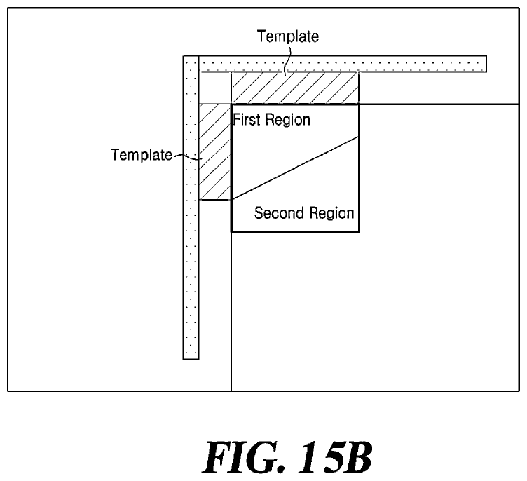

FIGS. 15A and 15B are diagrams illustrating templates and reference pixels used by a template-based intra-prediction mode derivation in geometric partitioning mode, according to at least some other embodiments of the present disclosure.

Referring to FIG. 15A, the current block may be partitioned into a first region and a second region according to the geometric partitioning mode. In geometric partitioning mode, a partitioning boundary may be present extending from top to bottom. There may be a template adjacent to the top of the first region and a template adjacent to the left side of the first region. The shape of the templates may be determined based on the first region. An MPM list may be generated by any of the MPM list generation methods described in FIGS. 11, 12A, and 12B. A prediction template may be generated by applying the respective candidate modes in the generated MPM list to reference pixels in the templates. The sum of absolute transformed difference between the pixels in the prediction template and the pixels in the already reconstructed template may be calculated. The candidate mode, which is in the MPM list, utilized to calculate the value with the smallest sum of absolute transformed difference may be the intra-prediction mode of the first region.

Referring to FIG. 15B, the current block may be partitioned into a first region and a second region according to a geometric partitioning mode. In the geometric partitioning mode, the partitioning boundary may be present extending from left to right. There may be a template adjacent to the top of the first region and a template adjacent to the left of the first region. The shape of the templates may be determined based on the first region. An MPM list may be generated by any of the MPM list generation methods described in FIGS. 11, 12A, and 12B. A prediction template may be generated by applying the respective candidate modes in the generated MPM list to reference pixels in the templates. The sum of absolute transformed difference may be calculated between the pixels in the prediction template and the pixels in the already reconstructed template. The candidate mode in the MPM list used to calculate the value with the smallest sum of absolute transformed difference may be the intra-prediction mode in the first region.

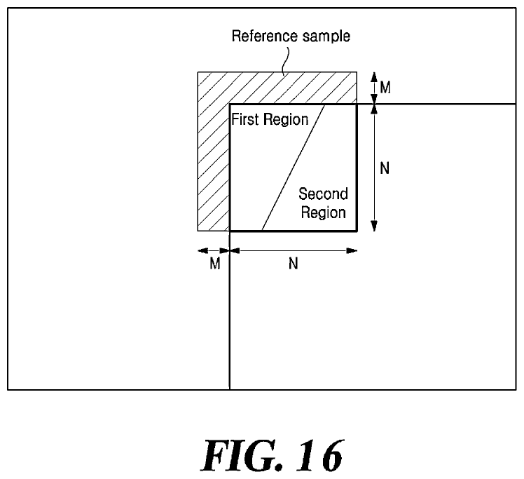

FIG. 16 is a diagram illustrating reference pixels for applying a sobel operation in geometric partitioning mode, according to at least one embodiment of the present disclosure. As for a method of deriving an intra-prediction mode based on a sobel operation, the present disclosure may apply a sobel filter to neighboring pixels of the current block. The slopes of those pixels may be calculated. Using the calculated slopes, a histogram of slopes may be generated. From the histogram of slopes, the slope with the largest value may be selected. By mapping the selected slope to an intra-prediction mode, the intra-prediction mode may be derived.

Referring to FIG. 16, the current block may be partitioned into a first region and a second region according to a geometric partitioning mode. Reference pixels may be present in the periphery of the current block. M may be equal to any number greater than or equal to 1. A sobel filter may be applied to the reference pixels. The slopes of the reference pixels may be calculated. Using the calculated slopes, a histogram of slopes may be generated. The slope with the largest value may be selected from the histogram of slopes. By mapping the selected slope to an intra-prediction mode, the intra-prediction mode of the first region may be derived.

In one example, the N slopes with the largest value may be selected from such a histogram of slopes. The N slopes may each be mapped to N intra-prediction modes. Using the N intra-prediction modes, N intra prediction blocks for the first region may be generated. A weighted average of the N intra prediction blocks for the first region may be generated to produce a final intra prediction block of the first region. The weight values may be arbitrary.

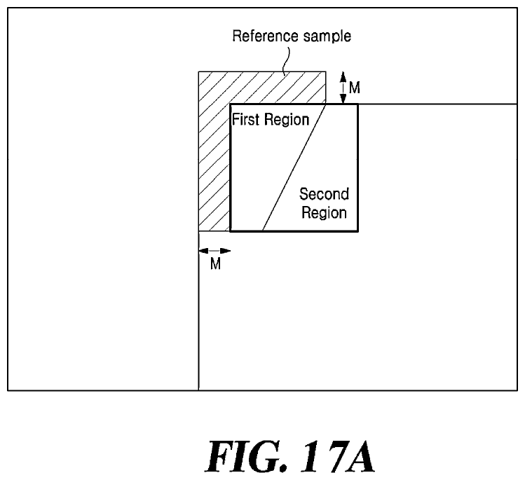

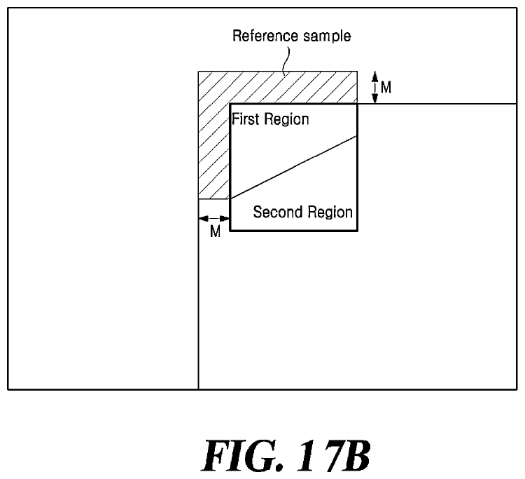

FIGS. 17A and 17B are diagrams illustrating reference pixels for applying a sobel operation in geometric partitioning mode, according to at least some other embodiments of the present disclosure.

Referring to FIG. 17A, according to the geometric partitioning mode, the current block may be partitioned into a first region and a second region. The partitioning boundary may be present extending from top to bottom. Reference pixels may be present on the periphery of the first region. M may be equal to any number greater than or equal to 1. The reference pixels may be determined based on the first region. A sobel filter may be applied to the reference pixels. Slopes of the reference pixels may be calculated. Using the calculated slopes, a histogram of slopes may be generated. From the histogram of slopes, the slope with the largest value may be selected. By mapping the selected slope to an intra-prediction mode, the intra-prediction mode of the first region may be derived.

In one example, from such a histogram of slopes, the N slopes with the largest value may be selected. The N slopes may each be mapped to N intra-prediction modes. Using the N intra-prediction modes, N intra prediction blocks for the first region may be generated. A weighted average of the N intra prediction blocks for the first region may be generated to produce a final intra prediction block of the first region. The weight values may be arbitrary.

Referring to FIG. 17B, the current block may be partitioned into a first region and a second region according to a geometric partitioning mode. The partitioning boundary may be present extending from left to right. Reference pixels may be present in the periphery of the first region. M may be equal to any number greater than or equal to 1. The reference pixels may be determined based on the first region. A sobel filter may be applied to the reference pixels. Slopes of the reference pixels may be calculated. Using the calculated slopes, a histogram of slopes may be generated. The slope with the largest value may be selected from the histogram of slopes. By mapping the selected slope to an intra-prediction mode, the intra-prediction mode of the first region may be derived.

In one example, from such a histogram of slopes, the N slopes with the largest value may be selected. The N slopes may each be mapped to N intra-prediction modes. Using the N intra-prediction modes, N intra prediction blocks for the first region may be generated. A weighted average of the N intra prediction blocks for the first region may be generated to produce a final intra prediction block of the first region. The weight values may be arbitrary.

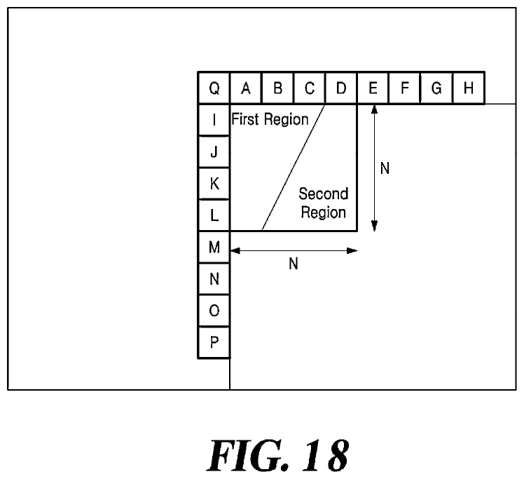

FIG. 18 is a diagram illustrating neighboring blocks of the current block for applying a histogram of modes in geometric partitioning mode, according to at least one embodiment of the present disclosure. As for a method of deriving intra-prediction modes based on a histogram of modes, the present disclosure may generate the histogram of modes by using intra-prediction modes of neighboring blocks of the current block. From the histogram of modes, the most frequently occurring intra-prediction mode may be selected. The selected intra-prediction mode may be derived as the intra-prediction mode of the current block.

Referring to FIG. 18, the current block may be partitioned into a first region and a second region according to a geometric partitioning mode. There may be a plurality of neighboring blocks in the periphery of the current block. The neighboring blocks of the current block may be A to Q blocks. The neighboring blocks of the current block may be equivalent to the smallest unit of blocks that store information on the intra-prediction mode. Using the intra-prediction modes in the A to Q blocks, a histogram of modes may be generated. From the histogram of modes, the most frequently occurring intra-prediction mode may be selected. The selected intra-prediction mode may be derived as the intra-prediction mode of the first region. The number and location of the neighboring blocks used to generate the histogram of modes may be arbitrarily determined. Generally, any location and any number of blocks among the Ato Q blocks may be used.

In one example, from such a histogram of modes, N intra-prediction modes with a high frequency of occurrence may be selected. Using the N intra-prediction modes, N intra prediction blocks for the first region may be generated. By weighted averaging the N intra prediction blocks for the first region, a final intra prediction block of the first region may be generated. The weight values may be determined by using the frequency of occurrence of the intra-prediction modes.

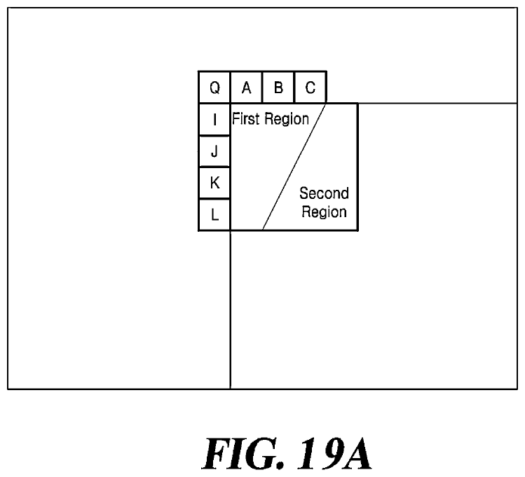

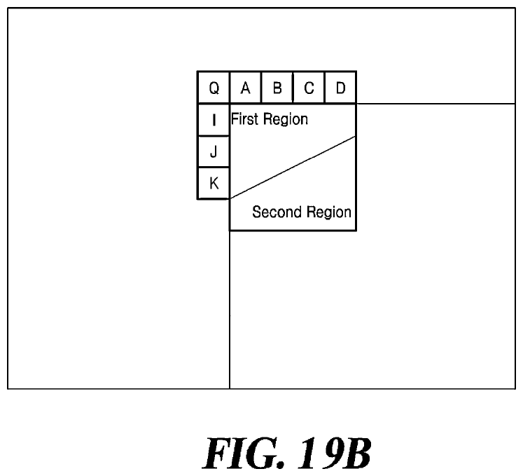

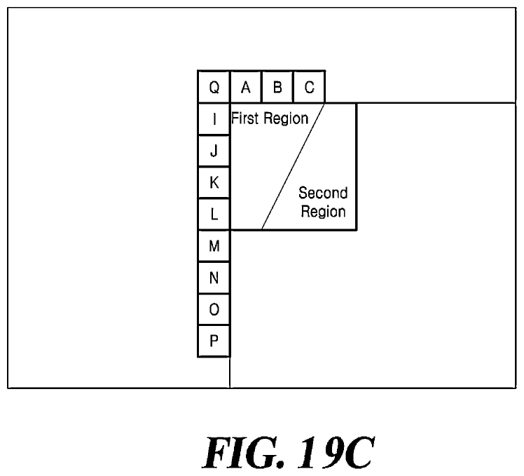

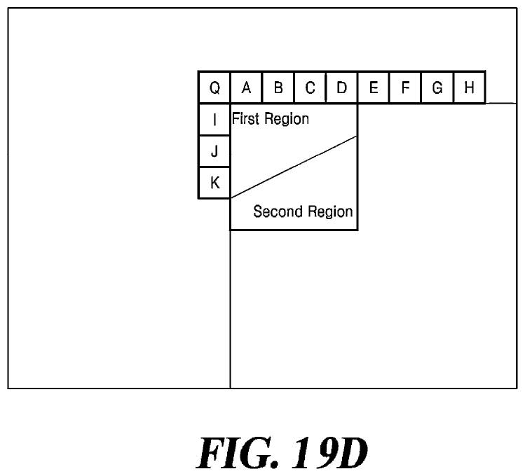

FIG. 19A, FIG. 19B, FIG. 19C, and FIG. 19D are diagrams illustrating neighboring blocks of the current block for applying a histogram of modes in geometric partitioning mode, according to at least some other embodiments of the present disclosure.

Referring to FIG. 19A, according to the geometric partitioning mode, the current block may be partitioned into a first region and a second region. There may be a plurality of neighboring blocks on the periphery of the first region. The partitioning boundary may be present extending from top to bottom. The neighboring blocks of the first region may be A to C blocks, I to L blocks, and Q block. The neighboring blocks of the first region may be the smallest unit of blocks that store information on the intra-prediction mode. Using the intra-prediction modes of the A to C blocks, I to L blocks, and Q block, a histogram of modes may be generated. From the histogram of modes, the most frequently occurring intra-prediction mode may be selected. The selected intra-prediction mode may be derived as the intra-prediction mode of the first region. The number and location of the neighboring blocks used to generate the histogram of modes may be arbitrarily determined. Generally, any location and any number of blocks may be used among the A to C blocks, the I to L blocks, and the Q block.

In one example, from such a histogram of modes, N intra-prediction modes with a high frequency of occurrence may be selected. Using the N intra-prediction modes, N intra prediction blocks for the first region may be generated. A final intra prediction block of the first region may be generated by weighted averaging the N intra prediction blocks of the first region. The weight values may be determined by using the frequency of occurrence of the intra-prediction modes.

Referring to FIG. 19B, according to the geometric partitioning mode, the current block may be partitioned into a first region and a second region. There may be a plurality of neighboring blocks on the periphery of the first region. The partitioning boundary may be present extending from left to right. The neighboring blocks of the first region may be A to D blocks, I to K blocks, and Q block. The neighboring blocks of the first region may be the smallest unit of blocks that store information on the intra-prediction mode. Using the intra-prediction modes of the A to D blocks, I to K blocks, and Q block, a histogram of the modes may be generated. From the histogram of modes, the most frequently occurring intra-prediction mode may be selected. The selected intra-prediction mode may be derived as the intra-prediction mode of the first region. The number and location of the neighboring blocks used to generate the histogram of modes may be arbitrarily determined. Generally, any location and any number of blocks among the A to D blocks, I to K blocks, and Q block may be used.

In one example, from such a histogram of modes, N intra-prediction modes with a high frequency of occurrence may be selected. Using the N intra-prediction modes, N intra prediction blocks for the first region may be generated. A final intra prediction block of the first region may be generated by weighted averaging the N intra prediction blocks of the first region. The weight values may be determined by using the frequency of occurrence of the intra-prediction modes.

Referring to FIG. 19C, according to the geometric partitioning mode, the current block may be partitioned into a first region and a second region. There may be a plurality of neighboring blocks on the periphery of the first region. The partitioning boundary may be present extending from top to bottom. The neighboring blocks of the first region may be A to C blocks, I to P blocks, and Q block. The neighboring blocks of the first region may be the smallest unit of blocks that store information on the intra-prediction mode. Using the intra-prediction modes of the A to C blocks, I to P blocks, and Q block, a histogram of the modes may be generated. From the histogram of modes, the most frequently occurring intra-prediction mode may be selected. The selected intra-prediction mode may be derived as the intra-prediction mode of the first region. The number and location of the neighboring blocks used to generate the histogram of modes may be arbitrarily determined. Generally, any location and any number of blocks may be used among the A to C blocks, I to P blocks, and the Q block.

In one example, from such a histogram of modes, N intra-prediction modes with a high frequency of occurrence may be selected. Using the N intra-prediction modes, N intra prediction blocks for the first region may be generated. A final intra prediction block of the first region may be generated by weighted averaging the N intra prediction blocks of the first region. The weight values may be determined by using the frequency of occurrence of the intra-prediction modes.

Referring to FIG. 19D, according to the geometric partitioning mode, the current block may be partitioned into a first region and a second region. There may be a plurality of neighboring blocks on the periphery of the first region. The partitioning boundary may be present extending from left to right. The neighboring blocks of the first region may be A to H blocks, I to K blocks, and Q block. The neighboring blocks of the first region may be the smallest unit of blocks that store information on the intra-prediction mode. Using the intra-prediction modes of the A to H blocks, I to K blocks, and Q block, a histogram of the modes may be generated. From the histogram of modes, the most frequently occurring intra-prediction mode may be selected. The selected intra-prediction mode may be derived as the intra-prediction mode of the first region. The number and location of the neighboring blocks used to generate the histogram of modes may be arbitrarily determined. Generally, any location and number of blocks among the A to H blocks, I to K blocks, and Q block may be used.

In one example, from such a histogram of modes, N intra-prediction modes with a high frequency of occurrence may be selected. Using the N intra-prediction modes, N intra prediction blocks for the first region may be generated. A final intra prediction block of the first region may be generated by weighted averaging the N intra prediction blocks of the first region. The weight values may be determined by using the frequency of occurrence of the intra-prediction modes.

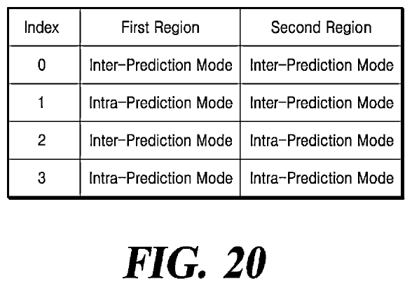

FIG. 20 is a diagram illustrating a method of combining an intra-prediction mode and an inter-prediction mode in geometric partitioning mode, according to at least one embodiment of the present disclosure. In geometric partitioning mode, certain prediction modes may be fixed and not used in the first and second regions. From a rate-distortion optimization (RDO) perspective, an optimal prediction mode may be used in the first region and the second region.

Referring to FIG. 20, when the index is 0, the first region may use inter-prediction mode and the second region may use inter-prediction mode. If the index is 1, the first region may use intra-prediction mode and the second region may use inter-prediction mode. If the index is 2, the first region may use inter-prediction mode and the second region may use intra-prediction mode. If the index is 3, the first region may use intra-prediction mode and the second region may use intra-prediction mode. If the first and second regions utilize the prediction modes without limitation, the accuracy of the prediction block can be improved and the coding efficiency can be improved. The present disclosure is not limited to these illustrative embodiments, and combinations of prediction modes in the first and second regions may be assigned arbitrary indexes. The combinations of prediction modes in the first region and the second region may be arbitrarily determined.

If the first and second regions use random prediction modes and a particular region uses an intra-prediction mode, that particular region may use the template-based intra-prediction mode derivation, the sobel operation-based intra-prediction mode derivation, or the mode histogram-based intra-prediction mode derivation described in FIGS. 14-19.

In one example, the present embodiment may exclude a case where both the first region and the second region utilize an intra-prediction mode. For example, the present embodiment may only allow cases where both the first region and the second region utilize an inter-prediction mode, where the first region utilizes an intra-prediction mode and the second region utilizes an inter-prediction mode, and where the first region utilizes an inter-prediction mode and the second region utilizes an intra-prediction mode.

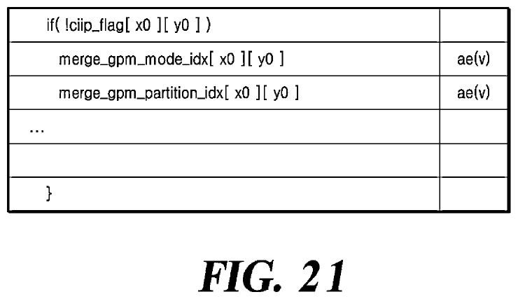

FIG. 21 is a diagram illustrating syntaxes for combining an intra-prediction mode and an inter-prediction mode in geometric partitioning mode, according to at least one embodiment of the present disclosure. In the illustrated embodiment, syntaxes associated with various combinations of intra-prediction and inter-prediction modes that the first region and second region utilize in geometric partitioning mode may be transmitted and parsed.

Referring to FIG. 21, information (e.g., merge_gpm_mode_idx) may be signaled indicative of a combination of intra-prediction and inter-prediction modes used by the first region and the second region. The merge_gpm_mode_idx may be signaled by using Fixed Length Coding (FLC) of 2 bits or truncated binary coding with a cMax of 3. The number of combinations may determine the number of bits in merge_gpm_mode_idx.

Through merge_gpm_mode_idx, the prediction modes used by the first region and second region may be determined. The merge_gpm_partition_idx may be signaled. The form of the partition may be determined via merge_gpm_partition_idx.

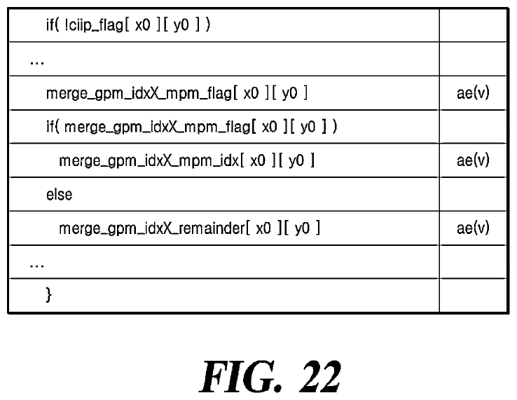

FIG. 22 is a diagram illustrating syntaxes for intra-prediction mode in geometric partitioning mode, according to at least one embodiment of the present disclosure.

Referring to FIG. 22, merge_gpm_idxX_mpm_flag and merge_gpm_idxX_mpm_idx, or merge_gpm_idxX_mpm_flag and merge_gpm_idxX_remainder may be signaled. Here, in_idxX_, X may be set to 0 and 1. If X is 0, _idx0_may indicate a syntax related to the first region. If X is 1, then_idx1_may represent a syntax related to the second region. If the first region utilizes intra-prediction mode, merge_gpm_idx0_mpm_flag and merge_gpm_idx0_mpm_idx, or merge_gpm_idx0_mpm_flag and merge_gpm_idx0_remainder may be signaled. If the second region utilizes intra-prediction mode, merge_gpm_idx1_mpm_flag and merge_gpm_idx1_mpm_idx, or merge_gpm_idx1_mpm_flag and merge_gpm_idx1_remainder may be signaled.

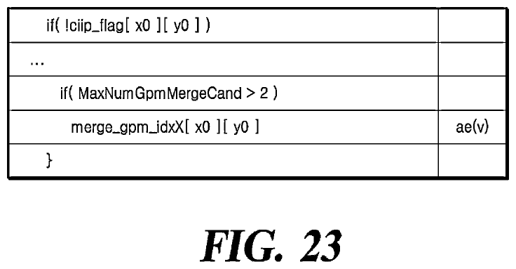

FIG. 23 is a diagram illustrating syntaxes for inter-prediction mode in geometric partitioning mode, according to at least one embodiment of the present disclosure.

Referring to FIG. 23, merge_gpm_idxX may be signaled. Here, in _idxX, X may be set to 0 and 1. If X is 0, then_idx0 may indicate a syntax related to the first region. If X is 1, _idx1 may represent a syntax related to the second region. If the first region utilizes inter-prediction mode, merge_gpm_idx0 may be signaled. If the second region utilizes inter-prediction mode, merge_gpm_idx1 may be signaled.

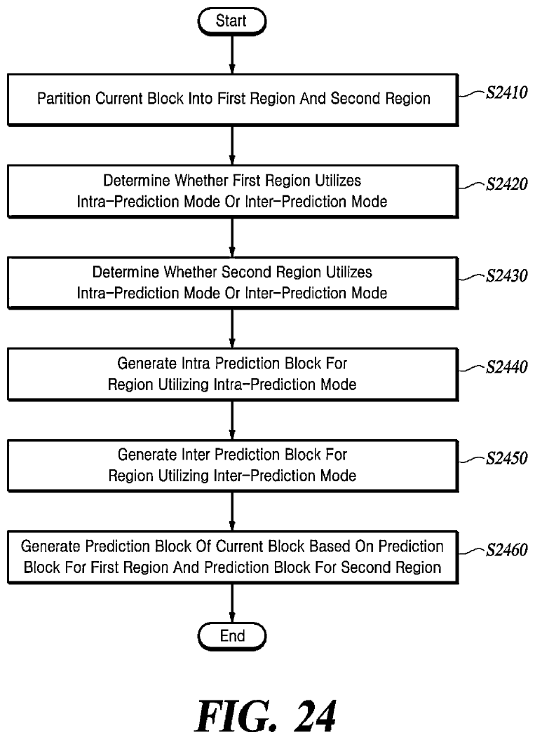

FIG. 24 is a diagram illustrating a video decoding process, according to at least one embodiment of the present disclosure.

Referring to FIG. 24, the video decoding apparatus may partition the current block into a first region and a second region (S2410). The video decoding apparatus may determine whether the first region utilizes intra-prediction mode or inter-prediction mode (S2420). The video decoding apparatus may determine whether the second region utilizes intra-prediction mode or inter-prediction mode (S2430). The video decoding apparatus may generate intra prediction block for any region that utilizes the intra-prediction mode (S2440). The intra prediction block for any region that utilizes the intra-prediction mode may be generated based on at least one of a most probable mode (MPM) list, intra-prediction modes of one or more blocks adjacent to the current block, one or more reference pixels adjacent to the current block, or a third region adjacent to the current block. The video decoding apparatus may generate inter prediction block for any region that utilizes the inter-prediction mode (S2450). Any region that utilizes the intra-prediction mode may be the upper left region of the current block, and any region that utilizes the inter-prediction mode may be the lower right region of the current block. The MPM list may be generated based on any region that utilizes the intra-prediction mode or at least one or more reference blocks adjacent to the current block.

The step of generating the intra prediction block for any region that utilizes the intra-prediction mode may include the steps of generating one or more prediction pixels by applying one or more candidate modes in the MPM list to one or more reference pixels in the third region adjacent to the current block, calculating a sum of absolute transformed difference between the one or more prediction pixels and one or more reconstructed pixels of the third region, and deriving, based on the sum of absolute transformed difference, the intra prediction block for any region that utilizes the intra-prediction mode. The third region may be determined based on the current block or any region that utilizes the intra-prediction mode.

The step of generating the intra prediction block for any region that utilizes the intra-prediction mode may include the steps of generating a list of slopes by applying a sobel operation to the one or more reference pixels adjacent to the current block, and deriving the intra prediction block for any region that utilizes the intra-prediction mode based on the list of slopes. The intra prediction block for any region that utilizes the intra-prediction mode may be derived based on a slope magnitude. The one or more reference pixels adjacent to the current block are determined based on the current block or any region that utilizes the intra-prediction mode.

The step of generating the intra prediction block for any region that utilizes an intra-prediction mode may include the steps of generating a list of intra-prediction modes based on the intra-prediction modes of the one or more blocks adjacent to the current block, and deriving the intra prediction block for any region that utilizes the intra-prediction mode based on the list of intra-prediction modes. The one or more blocks adjacent to the current block may be determined based on the current block or any region that utilizes the intra-prediction mode. The intra prediction block for any region that utilizes the intra-prediction mode is derived based on the frequency of occurrence of the intra prediction modes. The video decoding apparatus may generate a prediction block of the current block based on the prediction block generated for the first region and the prediction block generated for the second region (S2460).

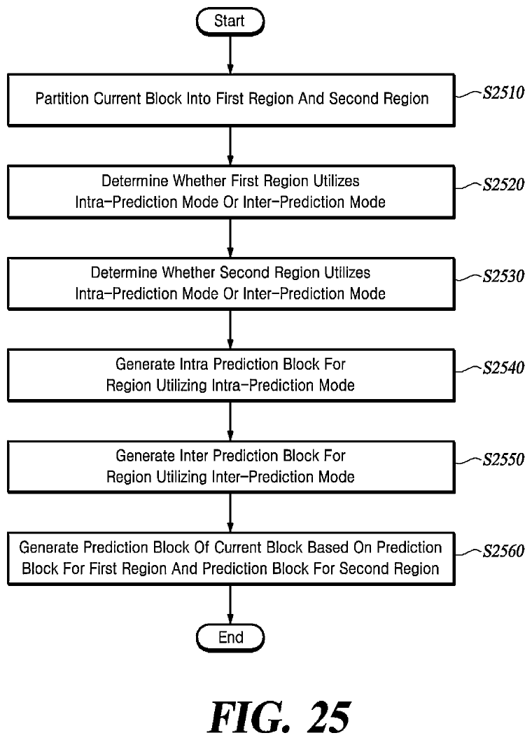

FIG. 25 is a diagram illustrating a video encoding process, according to at least one embodiment of the present disclosure.

Referring to FIG. 25, the video encoding apparatus may partition the current block into a first region and a second region (S2510). The video encoding apparatus may determine whether the first region utilizes intra-prediction mode or inter-prediction mode (S2520). The video encoding apparatus may determine whether the second region utilizes intra-prediction mode or inter-prediction mode (S2530). The video encoding apparatus may generate intra prediction block for any region that utilizes the intra-prediction mode (S2540). The intra prediction block for any region that utilizes the intra-prediction mode may be generated based on at least one of a most probable mode (MPM) list, intra-prediction modes of one or more blocks adjacent to the current block, one or more reference pixels adjacent to the current block, or a third region adjacent to the current block. The video encoding apparatus may generate inter prediction block for any region that utilizes the inter-prediction mode (S2550). Any region that utilizes the intra-prediction mode may be the upper left region of the current block, and any region that utilizes the inter-prediction mode may be the lower right region of the current block. The MPM list may be generated based on any region that utilizes the intra-prediction mode or at least one or more reference blocks adjacent to the current block.

The step of generating the intra prediction block for any region that utilizes the intra-prediction mode may include the steps of generating one or more prediction pixels by applying one or more candidate modes in the MPM list to one or more reference pixels in the third region adjacent to the current block, calculating a sum of absolute transformed difference between the one or more prediction pixels and one or more reconstructed pixels of the third region, and determining, based on the sum of absolute transformed difference, the intra prediction block for any region that utilizes the intra-prediction mode. The third region may be determined based on the current block or any region that utilizes the intra-prediction mode.

The step of generating the intra prediction block for any region that utilizes the intra-prediction mode may include the steps of generating a list of slopes by applying a sobel operation to the one or more reference pixels adjacent to the current block, and determining the intra prediction block for any region that utilizes the intra-prediction mode based on the list of slopes. The intra prediction block for any region that utilizes the intra-prediction mode may be determined based on a slope magnitude. The one or more reference pixels adjacent to the current block may be determined based on the current block or any region that utilizes the intra-prediction mode.

The step of generating the intra prediction block for any region that utilizes the intra-prediction mode may include the steps of generating a list of intra-prediction modes based on the intra-prediction modes of the one or more blocks adjacent to the current block, and determining the intra prediction block for any region that utilizes the intra-prediction mode based on the list of intra-prediction modes. The one or more blocks adjacent to the current block may be determined based on the current block or any region that utilizes the intra-prediction mode. The intra prediction block for any region that utilizes the intra-prediction mode may be determined based on the frequency of occurrence of the intra prediction modes. The video encoding apparatus may generate a prediction block of the current block based on the prediction block generated for the first region and the prediction block generated for the second region (S2560).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in various embodiments may be realized by hardware, software, firmware, and/or their combination. It should also be understood that the functional components described in this specification are labeled by “ . . . unit” to strongly emphasize the possibility of their independent realization.

Various methods or functions described above may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### REFERENCE NUMERALS

122: intra predictor
510: entropy decoder
542: intra predictor

What is claimed is:

1. A video decoding method, comprising:
partitioning a current block into a first region and a second region;
generating intra prediction block corresponding to the first region, based on at least one of a most probable mode (MPM) list, intra-prediction modes of one or more blocks adjacent to the current block, one or more reference pixels adjacent to the current block, or a third region adjacent to the current block;
generating inter prediction block corresponding to the second region; and
generating a prediction block of the current block, based on the intra prediction block and the inter prediction block.

2. The video decoding method of claim 1, wherein the first region is an upper left region of the current block, and the second region is a lower right region of the current block.

3. The video decoding method of claim 1, wherein the MPM list is generated based on the first region or at least one or more reference blocks adjacent to the current block.

4. The video decoding method of claim 1, wherein generating the intra prediction block corresponding to the first region comprises:
generating one or more prediction pixels by applying one or more candidate modes in the MPM list to one or more reference pixels of the third region adjacent to the current block;
calculating variable values based on differences between the one or more prediction pixels and one or more reconstructed pixels of the third region; and
deriving, based on the variable values, the intra prediction block corresponding to the first region.

5. The video decoding method of claim 4, wherein the third region is determined based on the current block or the first region.

6. The video decoding method of claim 1, wherein generating the intra prediction block corresponding to the first region comprises:
generating a list of slopes by using the one or more reference pixels adjacent to the current block; and
deriving the intra prediction block corresponding to the first region based on the list of slopes,
wherein the intra prediction block corresponding to the first region is derived based on a slope magnitude.

7. The video decoding method of claim 6, wherein the one or more reference pixels adjacent to the current block are determined based on the current block or the first region.

8. The video decoding method of claim 1, wherein generating the intra prediction block corresponding to the first region comprises:
generating a list of intra-prediction modes based on the intra-prediction modes of the one or more blocks adjacent to the current block; and
deriving the intra prediction block corresponding to the first region based on the list of intra-prediction modes.

9. The video decoding method of claim 8, wherein the one or more blocks adjacent to the current block are determined based on the current block or the first region.

10. The video decoding method of claim 8, wherein the intra prediction block corresponding to the first region is derived based on a frequency of occurrence of intra prediction modes in the list of intra-prediction.

11. A video encoding method, comprising:
partitioning a current block into a first region and a second region;
generating intra prediction block corresponding to the first region, based on at least one of a most probable mode (MPM) list, intra-prediction modes of one or more blocks adjacent to the current block, one or more reference pixels adjacent to the current block, or a third region adjacent to the current block;
generating inter prediction block corresponding to the second region; and
generating a prediction block of the current block, based on the intra prediction block and the inter prediction block.

12. The video encoding method of claim 11, wherein the first region is an upper left region of the current block, and the second region is a lower right region of the current block.

13. The video encoding method of claim 11, wherein the MPM list is generated based on the first region or at least one or more reference blocks adjacent to the current block.

14. The video encoding method of claim 11, wherein generating the intra prediction block corresponding to the first region comprises:
generating one or more prediction pixels by applying one or more candidate modes in the MPM list to one or more reference pixels of the third region adjacent to the current block;
calculating variable values based on differences between the one or more prediction pixels and one or more reconstructed pixels of the third region; and
determining, based on the variable values, the intra prediction block corresponding to the first region.

15. The video encoding method of claim 14, wherein the third region is determined based on the current block or the first region.

16. The video encoding method of claim 11, wherein generating the intra prediction block corresponding to the first region comprises:
generating a list of slopes by using the one or more reference pixels adjacent to the current block; and
determining the intra prediction block corresponding to the first region based on the list of slopes,
wherein the intra prediction block corresponding to the first region is determined based on a slope magnitude.

17. The video encoding method of claim 16, wherein the one or more reference pixels adjacent to the current block are determined based on the current block or the first region.

18. The video encoding method of claim 11, wherein generating the intra prediction block corresponding to the first region comprises:
generating a list of intra-prediction modes based on the intra-prediction modes of the one or more blocks adjacent to the current block; and
determining the intra prediction block corresponding to the first region based on the list of intra-prediction modes,
wherein the intra prediction block corresponding to the first region is determined based on a frequency of occurrence of intra prediction modes in the list of intra-prediction modes.

19. The video encoding method of claim 18, wherein the one or more blocks adjacent to the current block are determined based on the current block or the first region.

20. A method for transmitting a bitstream associated with video data, the method comprises:
generating the bitsream by encoding the video data; and
transmitting the bitstream to a video decoding apparatus,
wherein generating the bitstream comprises:
partitioning a current block into a first region and a second region;
generating intra prediction block corresponding to the first region, based on at least one of a most probable mode (MPM) list, intra-prediction modes of one or more blocks adjacent to the current block, one or more reference pixels adjacent to the current block, or a third region adjacent to the current block;
generating inter prediction block corresponding to the second region; and
generating a prediction block of the current block, based on the intra prediction block and the inter prediction block.
